(19) United States
(12) Patent Application Publication
(10) Pub. No.: US 2026/0160739 A1
(43) Pub. Date: Jun. 11, 2026

(54) SYSTEMS AND METHODS FOR A GAS CHROMATOGRAPHY MASS SPECTROMETRY FITTING

(71) Applicant: Agilent Technologies, Inc., Santa Clara, CA (US)

(72) Inventors: Derek Wolfe, Santa Clara, CA (US); Wesley Norman, Santa Clara, CA (US)

(73) Assignee: Agilent Technologies, Inc., Santa Clara, CA (US)

(21) Appl. No.: 18/974,570

(22) Filed: Dec. 9, 2024

(51) Int. Cl. G01N 30/72; B01D 53/02; G01N 30/02; G01N 30/30

(52) U.S. Cl. CPC G01N 30/7206; B01D 53/025; G01N 30/30; G01N 2030/025; G01N 2030/3084

(57) ABSTRACT

Systems and methods for a gas chromatography mass spectrometry fitting are described herein. An assembly can include a first fitting having a first flat surface, a first conduit, and a protrusion. The assembly can include a ferrule having a frustoconical surface, a second flat surface, and a second conduit. The second flat surface can be sealed against the protrusion. The assembly can include a tube disposed in the first conduit and the second conduit. The second conduit can define an interior surface of the ferrule. The interior surface of the ferrule can seal against an outer surface of the tube.

### TECHNICAL FIELD

The present application relates generally to mass spectrometry, including mass spectrometry coupled with gas chromatography.

### BACKGROUND

A mass spectrometry (MS) system typically includes an ion source for ionizing components (particularly molecules) of a sample under investigation, followed by one or more ion processing devices providing various functions, followed by a mass analyzer for separating ions based on their differing mass-to-charge ratios (or m/z ratios, or more simply “masses”), followed by an ion detector at which the mass-sorted ions arrive and are thereby detected (e.g., counted). The MS system further includes electronics for processing output signals from the ion detector as needed to produce user-interpretable data in a format such as a chromatogram or a mass spectrum, which typically presents as a series of peaks indicative of the relative abundances of detected ions (e.g., ion signal intensity such as number of ion counts for each ion detected) as a function of their m/z ratios. The mass spectrum (e.g., MS spectrum, MS fragment spectrum) may be utilized to determine the molecular structures of components of the sample, thereby enabling the sample to be qualitatively and quantitatively characterized, including the identification and abundance of chemical compounds of the sample (and possibly also isotopologues and/or isotopomers of each compound found in the analysis).

The mass spectrometry technique may be enhanced by coupling it with another analytical separation technique that precedes the MS analysis stage, thus serving as the first stage of analytical separation. Examples include chromatographic techniques such as liquid chromatography (LC) or gas chromatography (GC). Gas chromatography (GC) is used to analyze and detect the presence of many different substances in a sample. The sample can be in the gas phase during the analysis for gas chromatography. The function of a gas chromatograph is to separate the components of a chemical sample, known as analytes, and detect the identity and/or the concentration of those components. The separation is frequently accomplished using a capillary GC column. In some instances, this column is essentially a piece of fused silica tubing with a stationary phase coating on the inside that interacts with the sample to separate the components. A pressurized gas, known as the mobile phase, is used to push the sample through the column. The GC column can remain isothermal throughout an analysis or be ramped in temperature.

### SUMMARY

The performance of a gas chromatography mass spectrometry system and the lifetime of the mass spectrometer components can be negatively impacted by leaks at and around the transfer line. The solutions described herein can provide a gas chromatography mass spectrometry fitting that allows for a stable vacuum-tight connection between the mass spectrometer and the gas chromatograph.

At least one aspect of the present disclosure is directed to an assembly for a gas chromatography mass spectrometry system. The assembly can include a first fitting. The first fitting can include a first flat surface. The first fitting can include a first conduit intersecting with the first flat surface at a first conduit inlet. The first fitting can include a protrusion disposed on the first flat surface of the first fitting and around the first conduit inlet. The assembly can include a ferrule. The ferrule can include a frustoconical surface. The ferrule can include a second flat surface sealed against the protrusion. The ferrule can include a second conduit intersecting with the second flat surface at a second conduit inlet. The second conduit can be aligned with the first conduit. The assembly can include a tube disposed in the first conduit and the second conduit. The tube can be configured to extend through the first conduit inlet and the second conduit inlet. The second conduit can define an interior surface of the ferrule. The interior surface of the ferrule can be sealed against an outer surface of the tube.

Another aspect of the present disclosure is directed to a fitting for a gas chromatography mass spectrometry system. The fitting can include a first flat surface. The fitting can include a first conduit intersecting with the first flat surface at first conduit inlet. The fitting can include a protrusion disposed on the first flat surface of the fitting and around the first conduit inlet. The protrusion can be configured to deform a second flat surface of a ferrule. The ferrule can include a frustoconical surface. The second flat surface can be sealed against the protrusion.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a schematic diagram of a gas chromatography mass spectrometry system in accordance with an embodiment.

FIG. 2 is a perspective view of a portion of the gas chromatography mass spectrometry system in accordance with an embodiment.

FIG. 3 is a cross-sectional view of a portion of the gas chromatography mass spectrometry system in accordance with an embodiment.

FIG. 4 is a perspective view of a plurality of ferrules in accordance with an embodiment.

FIG. 5 is a perspective view of a fitting in accordance with an embodiment.

Like reference numbers and designations in the various drawings indicate like elements.

### DETAILED DESCRIPTION

Following below are more detailed descriptions of various concepts related to, and implementations of, methods, apparatuses, and systems for a gas chromatography mass spectrometry fitting. The various concepts introduced above and discussed in greater detail below may be implemented in any of a number of ways, as the described concepts are not limited to any particular manner of implementation. Examples of specific implementations and applications are provided primarily for illustrative purposes.

During operation of a gas chromatography mass spectrometry (GC-MS) system, the mass spectrometer can be under vacuum. A capillary column can interface with the high vacuum of the mass spectrometer at a transfer line of the GC-MS system. The performance of the GC-MS system and the lifetime of the mass spectrometer components can be negatively impacted by leaks at and around the transfer line. The transfer line can have multiple sealing surfaces that can be prone to leaking. Non-metal ferrules may be used, but they may not pre-swage onto the column and therefore, the position of the ferrule may not be fixed (e.g., predetermined) prior to use. If the position of the ferrule falls outside of a tolerance (e.g., ±1 mm), issues relating to the shape of peaks and/or sensitivity can arise. For example, if the ferrule is positioned such that an insertion depth is too short, analytes can expand into a volume before entering the source and cause peak shape issues. If the ferrule is positioned such that the insertion depth is too long, the insulating polymer coating of the capillary can build up charges and affect the ion source. This can cause sensitivity issues. If the ferrule cannot be pre-swaged, then the user would have to set the distance that the tube (e.g., column or restrictor) extends into the mass spectrometer source. Non-metal ferrules may also shrink after thermal cycling, which can introduce leaks into the vacuum system and require retightening of the ferrule.

The present disclosure is directed to systems and methods for a gas chromatography mass spectrometry fitting. The fitting can improve the GC-MS system performance by reducing or eliminating leaks at the interface between the mass spectrometer and the gas chromatograph. The disclosed solutions have a technical advantage of allowing metal ferrules to be used with the fitting. Metal ferrules can pre-swage permanently in place prior to use so they can be preinstalled onto columns. For example, metal ferrules can be pre-swaged in a manufacturing facility to set the distance the column extends into the mass spectrometer source. Additionally, metal ferrules can be more robust and resistant to shrinkage than non-metal ferrules during thermal cycling. However, it can be difficult to seal two flat metal surfaces without air incursion into the vacuum due to imperfections in the two metal surfaces and their inability to substantially deform when pressed against each other without an excessive amount of force that could damage parts of the system. The disclosed solutions can overcome the challenges of sealing a metal ferrule against the fitting and allow for a stable vacuum-tight connection between the mass spectrometer and the gas chromatograph.

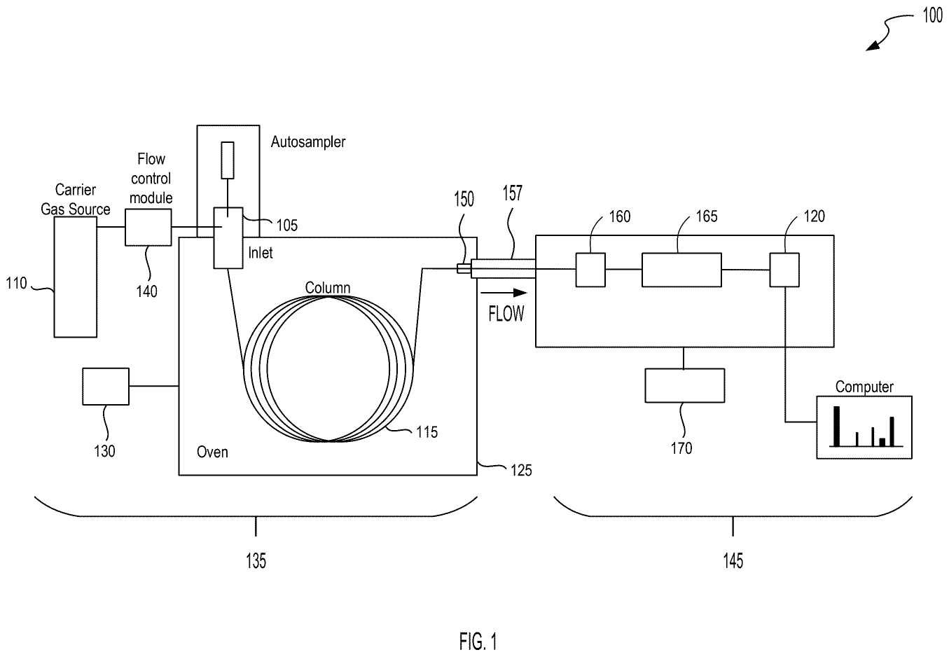

FIG. 1 is a schematic diagram of a gas chromatography mass spectrometry system 100. The GC-MS system 100 can include a representative GC-MS system. The GC-MS system 100 can include a gas chromatograph 135 (GC).

The gas chromatograph 135 can include one or more injection ports 105 (e.g., inlet, sample inlet). The injection port 105 can receive a sample injected into the gas chromatograph 135 for analysis. For example, the sample can be injected into the injection port 105 where, if not already in a gaseous state, it is vaporized into the gaseous state for analysis by the gas chromatograph 135.

The gas chromatograph 135 can include one or more pressurized gas sources 110 (e.g., pressurized gas supply, gas source, gas supply, supply gas). The pressurized gas source 110 can include a tank. The pressurized gas source 110 (e.g., carrier gas supply, carrier gas source, carrier gas) can be fluidly (e.g., fluidically) coupled with (e.g., connected to) the injection port 105. The pressurized gas source 110 can supply a carrier gas, such as but not limited to, helium, hydrogen, nitrogen, an argon/methane mixture, or other such inert gas, that transports the injected sample from the injection port 105 through the gas chromatograph 135. The pressurized gas source 110 can include a source of pressurized gas. The pressurized gas source 110 can be a gas distribution system of pressurized gases. The pressurized gases can be found in a laboratory. The pressurized gas source 110 can include multiple gases. The pressurized gas source 110 can be coupled with the gas chromatograph 135 via a distribution panel.

The gas chromatograph 135 can include one or more electronic pneumatic control (EPC) modules 140 (e.g., flow control modules). The electronic pneumatic control module 140 can be coupled with (e.g., connected to) the pressurized gas source 110. The electronic pneumatic control module 140 can be fluidly coupled with the injection port 105. For example, the injection port 105 can be attached to the electronic pneumatic control module 140. The electronic pneumatic control module 140 can control the flow and/or pressure of the injection port 105. The carrier gas can go to a first electronic pneumatic control module before going to the injection port 105. Each inlet can have its own electronic pneumatic control module 140. Each electronic pneumatic control module 140 can be coupled with the same gas supply or different gas supplies.

The gas chromatograph 135 can include one or more columns 115 (e.g., tube, restrictor, separation column). The column 115 can be fluidly coupled with the injection port 105. The column 115 can be selected from a wide variety of columns utilized to achieve separation of components of a sample by gas chromatography. Gas chromatographs 135 configured for backflushing, detector splitting, or other pneumatic switching can include multiple columns 115. The carrier gas can transport the sample from the injection port 105 to the column 115 for separation. The column 115 can separate the components of the gaseous sample to produce one or more analytes of interest for analysis by the gas chromatograph 135. The column 115 can include a capillary column and/or may include fused silica tubing with a coating (e.g., stationary phase coating) on the inner portions of the tubing that interacts with the sample injected into the injection port 105 to separate the components of the sample. The column 115 can be made of metal. Dimensions of the column 115 can include an inner diameter range of 50 μm (microns) to 530 μm and a length range of up to 200 meters. The injection port 105 can provide samples to the column 115 for separation. The column 115 can include a separation column or a column that serves as a restrictor fluidically connected to a separation column.

The gas chromatograph 135 can include one or more column heaters 125. The column heater 125 can include an oven, a convection heater, a conduction heater, an air bath, or other such heating device for heating certain components of the gas chromatograph 135. The column heater 125 can heat or cool the column 115 and other flow path components to desired temperatures. The column heater 125 can be configured to heat the column 115 such that the column 115 remains isothermal during sample analysis.

The gas chromatograph 135 can include one or more controllers 130. The controller 130 can be communicably connected, directly or indirectly, to the column heater 125, the injection port 105, one or more sensors, and/or other components of the gas chromatograph 135. The controller 130 can be electrically coupled with the gas chromatograph 135. The controller 130 can be an onboard computing component that is physically incorporated into the housing of the gas chromatograph 135 that contains the column 115, column heater 125, and other components of the gas chromatograph 135. The controller 130 can be one or more separate computing devices and/or other such controlling devices that are internal and/or external to the housing of the gas chromatograph 135. The controller 130 or a portion of the controller 130 can reside within the gas chromatograph 135. For example, the controller 130 or a portion of the controller 130 can be disposed in the gas chromatograph 135. The controller 130 can be split between multiple locations. The controller 130 can be disposed outside of the gas chromatograph 135.

The controller 130 can include one or more processors, such as but not limited to, a single-core processor, a multi-core processor, a logic device, or other such data processing circuitry, configured to execute, analyze, and process data and information of the gas chromatograph 135. The controller 130 can include a non-transitory memory device communicably connected to the processor. The memory device may be configured as a volatile memory device (e.g., SRAM and DRAM), a non-volatile memory device (e.g., flash memory, ROM, and hard disk drive), or any combination thereof. The memory device may store executable code and other such information that is generated and/or processed by the processor during operation of the gas chromatograph 135.

The gas chromatograph 135 can include one or more input/output devices communicably connected to the controller 130. The input/output device can enable an operator and/or user to receive information from the controller 130 and to input information and parameters into the controller 130. Such information and parameters can be stored in the memory device, accessed by the processor, and output to the input/output device. For example, the input/output device can include a monitor, display device, touchscreen device, keyboard, microphone, joystick, dial, button, or other such device to enable input and output of information and parameters. The input/output device may be utilized to input information into the controller 130 and output or otherwise display information and data generated by the processor of the gas chromatograph 135.

The GC-MS system 100 can include a mass spectrometer (MS) 145. The mass spectrometer 145 can include a transfer line 157 (e.g., MS transfer line, mass spectrometer transfer line). The transfer line 157 can couple (e.g., connect) the mass spectrometer 145 with the gas chromatograph 135. For example, the transfer line 157 can be inserted into the oven of the gas chromatograph 135. The transfer line 157 can include a tube with an inner diameter large enough to fit the column 115 within the tube. The column 115 can be disposed in the transfer line 157. For example, the column 115 can be inserted into the transfer line 157. The transfer line 157 can include a tube with a flange on the tube. The flange can seal to the side of the mass spectrometer 145. The transfer line 157 can be made of metal (e.g., stainless steel). The transfer line 157 can pass through a hole in the oven of the gas chromatograph 135. The transfer line 157 can be the interface between the capillary column and the high vacuum of the mass spectrometer 145.

The mass spectrometer 145 can include one or more fittings 150 (e.g., interface, union, ventless interface, ventless GC-MS interface). The fitting 150 can be made of stainless steel. The fitting 150 can be physically mounted on the transfer line 157. The fitting 150 can screw into the transfer line 157 or be clamped by alternative means. The fitting 150 can be disposed in (e.g., inserted into) the gas chromatograph 135. For example, the fitting 150 can be partially disposed in the gas chromatograph 135. The fitting 150 can be fluidically connected to the mass spectrometer 145. The fitting 150 can be welded or brazed to the transfer line 157. The fitting 150 can be securely attached to the transfer line 157. The fitting 150 can be machined out of the end of the transfer line 157. The fitting 150 can be permanently or non-permanently attached to the transfer line 157. The one or more fittings 150 and the transfer line 157 can couple to form a gas-tight (e.g., air-tight) seal. The fitting 150 can be fluidically connected to the column 115. The column 115 can be disposed in the fitting 150. The column 115 can extend from the gas chromatograph 135 through the transfer line 157. The column 115 can include a piece of tubing that transports the flow from the gas chromatograph 135 moving towards the mass spectrometer 145. The part of the column 115 that extends into the mass spectrometer 145 can include the separation column and/or analytical column. The part of column 115 that extends into the mass spectrometer 145 can include a flow restrictor (e.g., a column that is not coated with stationary phase). The column 115 can end at the fitting 150 and an additional piece of tubing can extend into the mass spectrometer 145.

The part of the column 115 that extends into and through the transfer line 157 can have an inner diameter in a range of 50 μm to 150 μm. For example, the inner diameter of the column 115 can be in a range of 50 μm to 75 μm, 50 μm to 100 μm, 50 μm to 125 μm, 50 μm to 150 μm, 75 μm to 100 μm, 75 μm to 125 μm, 75 μm to 150 μm, 100 μm to 125 μm, 100 μm to 150 μm, or 125 μm to 150 μm. The inner diameter of the column 115 can be less than 50 μm. The inner diameter of the column 115 can be greater than 150 μm.

The part of the column 115 that extends into and through the transfer line 157 can be made can be made of fused silica or metal (e.g., deactivated metal). This part of the column 115 can have a length in a range of 10 cm to 30 cm. For example, the length of this part of the column 115 can be in a range of 10 cm to 15 cm, 10 cm to 20 cm, 10 cm to 25 cm, 10 cm to 30 cm, 15 cm to 20 cm, 15 cm to 25 cm, 15 cm to 30 cm, 20 cm to 25 cm, 20 cm to 30 cm, or 25 cm to 30 cm. The length of this part of the column 115 can be less than 10 cm. The length of this part of the column 115 can be greater than 30 cm.

The mass spectrometer 145 can include an ion source 160 (e.g., ionization apparatus, mass spectrometer source, MS source). The output of the gas chromatograph 135 can be provided to the ion source 160. The ion source 160 can be fluidically connected to the fitting 150 by (e.g., via) the column 115 and can be downstream of the column 115. The ion source 160 can produce analyte ions from a sample stream received from the gas chromatograph 135. The ion source 160 can include an electron impact apparatus or a chemical ionization apparatus. The column 115 can extend from the gas chromatograph 135 through the transfer line 157 to the ion source 160.

The mass spectrometer 145 can include a mass analyzer 165. The ion source 160 can direct the analyte ions into the mass analyzer 165. The mass analyzer 165 can include a device configured to separate, sort, or filter analyte ions on the basis of their respective masses (e.g., mass-to-charge ratios, or m/z ratios). Examples of mass analyzers 165 can include multipole electrode structures (e.g., mass filters, ion traps), time-of-flight (TOF) components, electrostatic analyzers (ESAs), or magnetic sectors. The mass analyzer 165 can include a system of more than one mass analyzer. The mass analyzer 165 can be fluidically coupled with the ion source 160.

The mass spectrometer 145 can include an ion detector 120. The ion detector 120 can include a device configured to collect and measure the flux (or current) of mass-discriminated ions outputted from the mass analyzer 165. Examples of ion detectors 120 can include electron multipliers, photomultipliers, and Faraday cups. The ion detector 120 can be fluidically coupled with the mass analyzer 165.

The mass spectrometer 145 can include a vacuum system 170. The vacuum system 170 can maintain the ion source 160 at a desired low pressure or vacuum level. The vacuum system 170 can maintain the mass analyzer 165 and ion detector 120 at desired vacuum levels. The vacuum system 170 can include one or more vacuum pumps. The vacuum system 170 can keep the one or more components (e.g., chambers) of the mass spectrometer 145 at a desired vacuum level.

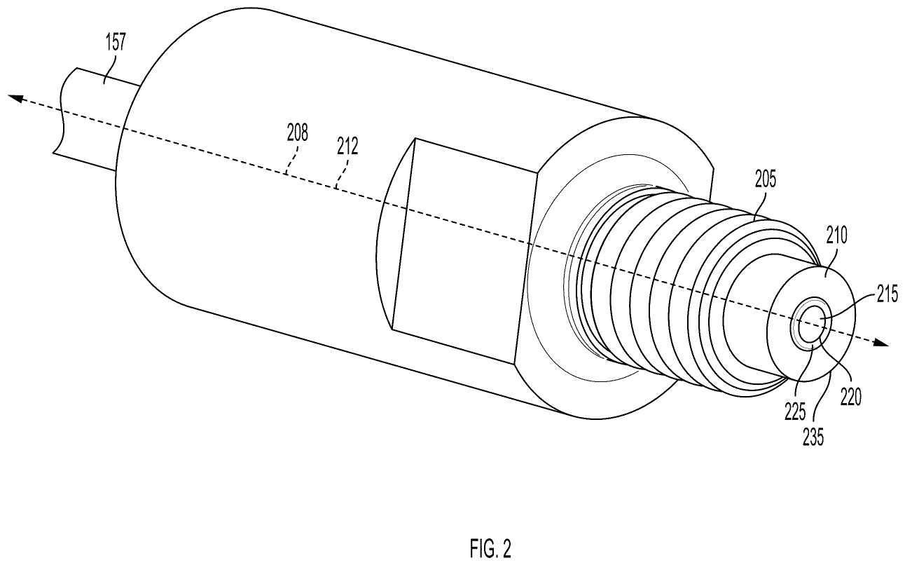

FIG. 2 is a perspective view of a portion of the GC-MS system 100. The GC-MS system 100 can include a first fitting 205. The one or more fittings 150 can include the first fitting 205. The first fitting 205 can be integrated into the transfer line 157. The first fitting 205 can be part of the transfer line 157. The first fitting 205 can be a transfer line tip. The first fitting 205 can be attached to the transfer line 157. For example, the first fitting 205 can screw into or onto the transfer line 157. The first fitting 205 can be machined out of the end of the transfer line 157. The first fitting 205 can be permanently (e.g. through welding or brazing) or non-permanently attached to the transfer line 157. The first fitting 205 and the transfer line 157 can couple to form a gas-tight seal. The first fitting 205 can be fluidically connected to the mass spectrometer 145. For example, the first fitting 205 can be fluidically connected to the mass spectrometer 145 by the column 115. The first fitting 205 can be disposed at a first end of the transfer line 157. The first fitting 205 can be disposed inside the oven of the gas chromatograph 135. The first fitting 205 can be made of metal (e.g., stainless steel, heat-treatable steels with electroless Nickel or Titanium Nitride coatings). The first fitting 205 can be corrosion-resistant. The first fitting 205 can withstand temperatures that the oven of gas chromatograph 135 is heated to.

The first fitting 205 can include a first flat surface 210. The first flat surface 210 can be disposed at an end of the first fitting 205. The first flat surface 210 can be oriented perpendicular to a longitudinal axis 208 of the first fitting 205. The first flat surface 210 can have a shape defined by an annulus. The first flat surface 210 can have an inner diameter in a range of 100 μm to 2 mm. The first flat surface 210 can have an outer diameter in a range of 2 mm to 10 mm. The outer diameter of the first flat surface 210 can be greater than the inner diameter of the first flat surface 210.

The first fitting 205 can include a first conduit 215. The first conduit 215 can intersect with the first flat surface 210. For example, the first conduit 215 can intersect with the first flat surface 210 at a first conduit inlet 220. The first conduit inlet 220 can be disposed at the end of the first fitting 205. The first conduit 215 can be oriented parallel to the longitudinal axis 208 of the first fitting 205. The first conduit 215 can be oriented perpendicular to the first flat surface 210. The first flat surface 210 can extend in a plane perpendicular to a longitudinal axis 212 of the first conduit 215. The longitudinal axis 208 of the first fitting 205 and the longitudinal axis 212 of the first conduit 215 can be parallel. The longitudinal axis 208 of the first fitting 205 and the longitudinal axis 212 of the first conduit 215 can overlap. The first conduit 215 can have a diameter in a range of 100 μm to 2 mm. The diameter of the first conduit 215 can be the same as the inner diameter of the first flat surface 210.

The first fitting 205 can include a protrusion 225 (e.g., bump, edge, ridge). The protrusion 225 can have a rounded surface. The protrusion 225 can be disposed on the first flat surface 210 of the first fitting 205. The protrusion 225 can be disposed around the first conduit inlet 220. For example, the protrusion 225 can abut the first conduit inlet 220. The protrusion 225 can be disposed on an outermost edge of the first fitting 205. The protrusion 225 can be disposed on an outermost surface of the first fitting 205.

The protrusion 225 can have a first hardness. The protrusion 225 can have a hardness in a range of HK 140 to HK 200 as measured by a Knoop hardness test. The protrusion 225 can have a hardness greater than HK 200. The protrusion 225 can work harden with each use. The hardness of the protrusion 225 and the hardness of the fitting 150 can be the same. The hardness of the protrusion 225 can be greater than the hardness of the fitting 150 if the protrusion 225 is work hardening with one or multiple uses. The protrusion 225 can have a first ductility. The ductility of the protrusion 225 and the hardness of the fitting 150 can be the same. The protrusion 225 can be radially symmetric (e.g., have radial symmetry). The protrusion 225 can have a shape defined by at least one of a circle, a ring, a square, an ellipse, a triangle, or a polygon. The protrusion 225 can have a shape defined by a half-torus. The protrusion 225 can include a knife edge. The protrusion 225 can be annular. For example, the protrusion 225 can include an annular rib. The protrusion 225 can have a semi-circular cross-section. The protrusion 225 can have a cross-section defined by a segment of a circle (e.g., enclosed by a chord and an arc between the endpoints of the chord). The protrusion 225 can have a triangular cross-section.

The protrusion 225 can have a shape defined by a ring. The protrusion 225 and the first conduit inlet 220 can be concentric. The protrusion 225 can have an inner diameter (e.g., inner diameter of the ring) that is equal to or greater than a diameter of the first conduit 215. The protrusion 225 can have an outer diameter (e.g., outer diameter of the ring) that is greater than the diameter of the first conduit 215. The outer diameter of the protrusion 225 can be in a range of 100 μm to 6 mm. The inner diameter of the protrusion 225 can be equal to or greater than a diameter of the first conduit inlet 220. The inner diameter of the protrusion 225 can be greater than the diameter of the first conduit inlet 220. The inner diameter of the protrusion 225 can be in a range of 50 μm to 5 mm. A width of the protrusion 225 can be calculated by subtracting the inner diameter of the protrusion 225 from the outer diameter of the protrusion 225 and dividing the result by two. The width of the protrusion 225 can be in a range of 50 μm to 1 mm. The width of the protrusion 225 can be less than or equal to a half of the difference between the outer diameter of the first flat surface 210 and the inner diameter of the first flat surface 210. The protrusion 225 can have a height in a range of 50 μm to 2 mm.

The protrusion 225 can be disposed between the first conduit inlet 220 and an outer edge 235 of the first flat surface 210. For example, the protrusion 225 can be disposed halfway between the first conduit inlet 220 and the outer edge 235 of the first flat surface 210. A distance between an inner edge of the protrusion 225 and the first conduit inlet 220 can be less than a distance between an outer edge of the protrusion 225 and the outer edge 235 of the first flat surface 210. The distance between the inner edge of the protrusion 225 and the first conduit inlet 220 can be equal to the distance between the outer edge of the protrusion 225 and the outer edge 235 of the first flat surface 210. The distance between the inner edge of the protrusion 225 and the first conduit inlet 220 can be greater than the distance between the outer edge of the protrusion 225 and the outer edge 235 of the first flat surface 210. The outer edge 235 of the first flat surface 210 can include the outermost edge of the first flat surface 210.

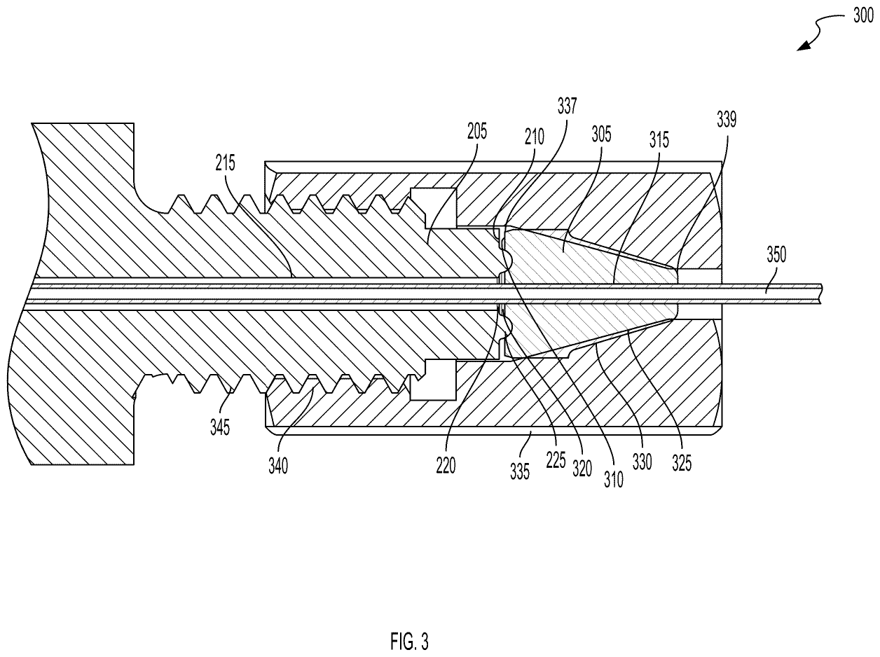

FIG. 3 is a cross-sectional view of a portion of the GC-MS system 100. The portion of the GC-MS system 100 can include an assembly 300 (e.g., fitting assembly, apparatus, fitting apparatus). The assembly 300 can be used for a gas chromatography fitting. The assembly 300 can be attached to a component of the gas chromatograph 135 such as an inlet or detector. The assembly 300 can be used for a mass spectrometry fitting. The assembly 300 can include the one or more fittings 150. The assembly 300 can include the first fitting 205. The assembly 300 can include a second fitting 335. The one or more fittings 150 can include the second fitting 335.

The assembly 300 can include a ferrule 305. A surface (e.g., surface portion) of the ferrule 305 can have a second hardness. For example, the surface of the ferrule 305 can have a hardness in a range of HK 20 to HK 90 as measured by a Knoop hardness test. The second hardness can be less than the first hardness. For example, the hardness of the surface of the ferrule 305 can be less than the hardness of the protrusion 225. The surface of the ferrule 305 can be softer than the protrusion 225 such that the surface of the ferrule 305 is deformed by the protrusion 225. The ferrule 305 can be made of annealed metal or graphite/Vespel® materials. The surface of the ferrule 305 can be formed via a heat treatment method to anneal the surface.

The ferrule 305 can be made of a coated substrate. For example, the ferrule 305 can have a substrate made of stainless steel (e.g., annealed or unannealed 300-series stainless steel) with a coating (e.g., overcoat, plating) of gold. The coating of the ferrule 305 can be softer than the protrusion 225 such that the coating of the ferrule 305 is deformed by the protrusion 225. In some embodiments, the coating can include silver or a metal that is softer than the protrusion 225. The coating of the ferrule can include at least one of gold, silver, brass, copper, plastic, or graphite. Metal coatings can be used for oven temperatures greater than 300° C. The ferrule 305 can be softer than the protrusion 225. For example, the outer coating of the ferrule 305 can be softer than the protrusion 225. The surface coating of the ferrule 305 can be softer than the protrusion 225. The surface of the ferrule 305 can include the surface coating of the ferrule 305.

The substrate of the ferrule 305 can have a hardness in a range of HK 140 to HK 200 and the coating can have a hardness in a range of HK 20 to HK 90. The substrate of the ferrule 305 can be made of a bulk material. The substrate of the ferrule 305 can have a hardness that is greater than, less than, or equal to the hardness of the surface of the ferrule 305. Compression of the protrusion 225 can work harden the protrusion 225. The ferrule 305 can have a second ductility. The second ductility can be greater than the first ductility. For example, the ductility of the ferrule 305 can be greater than the ductility of the protrusion 225. The bulk material of the ferrule 305 can be made of at least one of a metal (e.g., stainless steel, copper, brass), graphite, or polyimide (e.g., polyimide-based plastic, Vespel® materials). For example, the ferrule 305 can be stainless steel plated with gold (e.g., gold-plated stainless steel). The gold can fill in surface imperfections from machining the ferrule 305. The gold can be deposited as a layer of material onto the stainless steel substrate that is easier to deform than the substrate. The ferrule 305 can have a frustoconical or conical shape. For example, the ferrule 305 can have a first end 337 and a second end 339. A portion of the ferrule 305 at the first end 337 can have a larger outer diameter than a portion of the ferrule 305 at the second end 339. The portion of the ferrule 305 at the first end 337 can taper towards the portion of the ferrule 305 at the second end 339. The second end 339 (e.g., nose of the ferrule 305) can hang in space to allow the ferrule 305 to engage with the second fitting 335).

The ferrule 305 can include a frustoconical surface 325. In some embodiments, the frustoconical surface 325 can form a seal with an interior surface 330 of the second fitting 335. For example, the frustoconical surface 325 can seal against the interior surface 330 of the second fitting 335. The ferrule 305 can conform to the interior surface 330 of the second fitting 335. For example, the ferrule 305 can form a seal with the interior surface 330 of the second fitting 335. The ferrule 305 can seal against the interior surface 330 of the second fitting 335. The frustoconical surface 325 can provide the compression force for the seal between an inner diameter of the ferrule 305 (e.g., second conduit 315) and an outer diameter of the column 115.

The second fitting 335 can include first threads 340. For example, the first threads 340 can include #10-32 UNF threads. The first fitting 205 can include second threads 345. For example, the second threads 345 can include #10-32 UNF threads. The second threads 345 can mate with the first threads 340. Mating of the first threads 340 and the second threads 345 can provide compression of the ferrule 305. The first threads 340 and the second threads 345 can allow the first fitting 205 to mechanically couple with the second fitting 335. For example, the first fitting 205 can be screwed into the second fitting 335. The second fitting 335 can be screwed onto the first fitting 205. The second fitting 335 and the first fitting 205 can be sealed at finger tight plus a quarter turn. The second fitting 335 and the first fitting 205 can be sealed at finger tight plus 10 to 20 degrees. The first fitting 205 can be attached (e.g., securely attached) to the second fitting 335. The coupling of the first fitting 205 to the second fitting 335 can compress the ferrule 305 against the first fitting 205 and the second fitting 335. The coupling of the first fitting 205 to the second fitting 335 can compress the ferrule 305 against the protrusion 225. The coupling of the first fitting 205 to the second fitting 335 can allow the frustoconical surface 325 to be compressed by the interior surface 330 of the second fitting 335 (e.g., a mating frustoconical surface of the second fitting 335) to seal the inner diameter of the ferrule 305 to an outer diameter of the column 115.

The ferrule 305 can include a second flat surface 310. The second flat surface 310 can be disposed at the first end 337 of the ferrule 305. The second flat surface 310 can seal against (e.g., form a gas-tight connection with) the protrusion 225. The second flat surface 310 can be oblique to the frustoconical surface 325. The frustoconical surface 325 can be oblique to the second flat surface 310. For example, the frustoconical surface 325 can intersect the second flat surface 310 at a non-perpendicular angle. The second flat surface 310 can abut the first flat surface 210. The second flat surface 310 can be physically separated from the first flat surface 210. The second flat surface 310 can physically contact the first flat surface 210. The second flat surface 310 can be parallel to the first flat surface 210 without physically contacting the first flat surface 210. A diameter of the second flat surface 310 can be greater than the diameter of the first flat surface 210. The diameter of the second flat surface 310 can be equal to the diameter of the first flat surface 210. The diameter of the second flat surface 310 can be less than the diameter of the first flat surface 210. The inner diameter of the protrusion 225 can be less than or equal to the diameter of the second flat surface 310.

The protrusion 225 can deform the second flat surface 310. For example, the protrusion 225 can deform (e.g., indent, cut into, stamp) the second flat surface 310 such that the second flat surface 310 seals against the protrusion 225. The protrusion 225 can cause a deformation of the ferrule 305 that cuts through surface imperfections of the ferrule 305 and makes a vacuum-tight seal. The protrusion 225 can form a deformation on the second flat surface 310 of the ferrule 305. For example, the protrusion 225 can dig into the ferrule 305 to form the deformation. The deformation can have a depth in a range of 1 μm to 300 μm. The deformation can have a depth that is greater than or equal to a depth of any imperfections on the second flat surface 310 of the ferrule 305. When the second flat surface 310 seals against the protrusion 225, the second flat surface 310 can become deformed such that a portion of the second flat surface 310 is no longer flat. The portion of the second flat surface 310 that has been deformed by the protrusion 225 can be an indentation formed by the protrusion. In some embodiments, when the second flat surface 310 seals against the protrusion 225, the second flat surface 310 abuts the first flat surface 210. In some embodiments, when the second flat surface 310 seals against the protrusion 225, the second flat surface 310 is disposed a distance from the first flat surface 210. The second flat surface 310 can deform when making a seal with the protrusion 225.

The protrusion 225 can be a knife edge that forms a knife edge seal against the second flat surface 310. The knife edge can concentrate the force between the ferrule 305 and the first fitting 205 onto an area that is smaller than an area of overlap between the first flat surface 210 and the second flat surface 310. The first fitting 205 can seal against a portion of the second flat surface 310. The portion of the second flat surface 310 that the first fitting 205 seals against can be a contact area. The contact area between the first flat surface 210 and the portion of the second flat surface 310 can be greater than the contact area between the protrusion 225 and the portion of the second flat surface 310. The contact area between the protrusion 225 and the portion of the second flat surface 310 can be less than the contact area between the first flat surface 210 and the portion of the second flat surface 310. The protrusion 225 can reduce the contact area between the first fitting 205 and the second flat surface 310 compared to the contact area between the first flat surface 210 and the second flat surface 310. A portion of the protrusion 225 that contacts the second flat surface 310 can be round or sharp (as opposed to flat).

The protrusion 225 can reduce the minimum force to make a vacuum-tight seal between the first fitting 205 and a component the first fitting 205 is configured to seal against. For example, the protrusion 225 can reduce minimum force needed to make a vacuum-tight seal between the first fitting 205 and the ferrule 305. Trying to seal two flat metal surfaces without the protrusion 225 may not allow for a vacuum-tight seal without air incursion. The protrusion 225 can allow for vacuum-tight ferrule connections. A metal ferrule can be sealed against the end of the transfer line 157 with the protrusion 225 because the protrusion 225 can dig into the softer metal ferrule surface and reduce the effect of any imperfections in the flat surface of the ferrule 305. The minimum force to seal the first flat surface 210 without the protrusion 225 against the ferrule 305 can be greater than the minimum force to seal the first flat surface 210 with the protrusion 225 against the ferrule 305. Using less force to seal the first fitting 205 against the ferrule 305 can reduce the probability of damaging components of the GC-MS system 100. For example, the minimum force to seal the first flat surface 210 without the protrusion 225 against the ferrule 305 can be high enough to damage or crush the column 115. The minimum force to seal the first flat surface 210 with the protrusion 225 against the ferrule 305 can be lower than the force sufficient to damage or crush the column 115.

The knife edge can be harder than the surface it seals against (e.g., the second flat surface 310 of the ferrule 305). If the knife edge was softer than the surface it seals against, then the knife edge would become crushed or smashed when pressed against the surface, rather than being able to deform or cut through the surface. To make a seal, the crushed material would need to extrude into surface defects, which could be an issue because crushed metal work hardens and does not extrude well, so a deep scratch is not likely to seal. Additionally, the ferrule 305 is typically a disposable part, and the first fitting 205 is typically a non-disposable part. If the knife edge was instead place on the ferrule 305, damage could accumulate on the surface of the non-disposable part from repeated applications of a knife edge being pressed against the surface. This could cause issues with sealing because the surface can become irregular and contain patterns from previous use. When the knife edge is harder than the surface it seals against, the knife edge can cut through any imperfections on the surface which can allow for a more reliable seal. Additionally, more complex machined features such as the knife edge can be on the non-disposable part (e.g., the first fitting 205) rather than on the disposable part (e.g., the ferrule 305).

The ferrule 305 can include a second conduit 315. The second conduit 315 can intersect with the second flat surface 310. For example, the second conduit 315 can intersect with the second flat surface 310 at a second conduit inlet 320. The second conduit 315 can be aligned with the first conduit 215. The second conduit 315 can define an interior surface of the ferrule 305. The second flat surface 310 can extend in a plane perpendicular to a longitudinal axis of the second conduit 315. The first flat surface 210 can extend in the plane perpendicular to the longitudinal axis of the second conduit 315. The longitudinal axis of the second conduit 315 can be parallel with the longitudinal axis 208 of the first fitting 205. The longitudinal axis of the second conduit 315 and the longitudinal axis 208 of the first fitting 205 can overlap. The longitudinal axis of the second conduit 315 can be parallel with the longitudinal axis 212 of the first conduit 215. The longitudinal axis of the second conduit 315 and the longitudinal axis 212 of the first conduit 215 can overlap.

The assembly 300 can include a tube 350 (e.g., restrictor tube, column). The tube 350 can be disposed in the first conduit 215. The tube 350 can be disposed in the second conduit 315. The tube 350 can extend through the first conduit inlet 220. The tube 350 can extend through the second conduit inlet 320. The second conduit 315 can form a seal with the outer surface of the tube 350. For example, the interior surface of the ferrule 305 can form a seal with an outer surface of the tube 350. For example, the interior surface of the ferrule 305 can seal against the outer surface of the tube 350. The compression of the ferrule 305 can be caused by mating of the second fitting 335 with the first fitting 205. The shape of the ferrule 305 can allow the second conduit 315 to seal against the outer surface of the tube 350. For example, the shape of the ferrule 305 can allow the frustoconical surface 325 of the ferrule 305 to be compressed by the mating frustoconical surface of the second fitting 335. The mating frustoconical surface of the second fitting 335 can press on the frustoconical surface 325 of the ferrule 305 to cause a seal between an inner diameter of the ferrule 305 and an outer diameter of the tube 350.

The ferrule 305 can be disposed a fixed (e.g., predetermined) distance from a first end of the tube 350 (e.g., the end of the tube 350 that is on the MS side or that sticks into the ion source 160). For example, the ferrule 305 can be pre-swaged onto the column 115 or tube 350. The ferrule 305 can be pre-swaged permanently onto the column 115 or tube 350. The ferrule 305 can be affixed to the column 115 or tube 350 as an integrated component received by the user. This can eliminate the need for the user to measure and affix the ferrule 305 to the column 115 or tube 350.

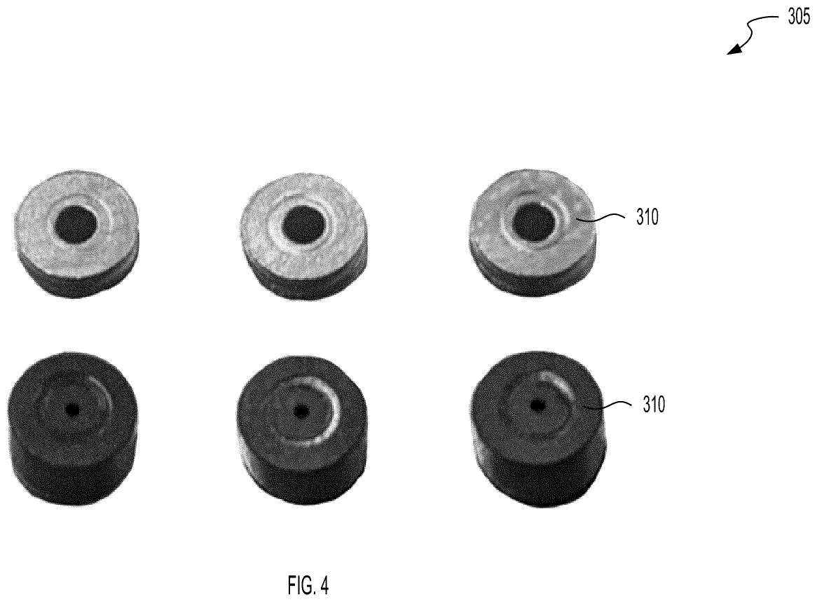

FIG. 4 is a perspective view of a plurality of ferrules 305. Each of the plurality of ferrules 305 can include the second flat surface 310. The plurality of ferrules 305 are shown after the first fitting 205 has been (1) coupled to each of the plurality of ferrules 305 and (2) decoupled from each of the plurality of ferrules 305. The coupling of the first fitting 205 to each of the plurality of ferrules 305 causes the protrusion 225 to deform the second flat surface 310 of each of the plurality of ferrules 305.

Coining on the second flat surface 310 of each of the plurality of ferrules 305 is visible on both the gold plated ferrules (top row) and graphite/Vespel® material ferrules (bottom row). The protrusion 225 has deformed (e.g., plastically deformed) the second flat surface 310 of each of the plurality of ferrules 305 such that a protrusion-shaped mark has been left on the second flat surface 310 of each of the plurality of ferrules 305. The protrusion 225 can be resealed against the second flat surface 310 of the ferrule 305. For example, the protrusion 225 can be aligned with the mark left by the protrusion 225 and pressed up against the second flat surface 310 of the ferrule 305. The mark left by the protrusion 225 can aid in alignment of the first fitting 205 with the second flat surface 310 of the ferrule 305. The mark left by the protrusion 225 can aid in alignment of the first conduit 215 and the second conduit 315.

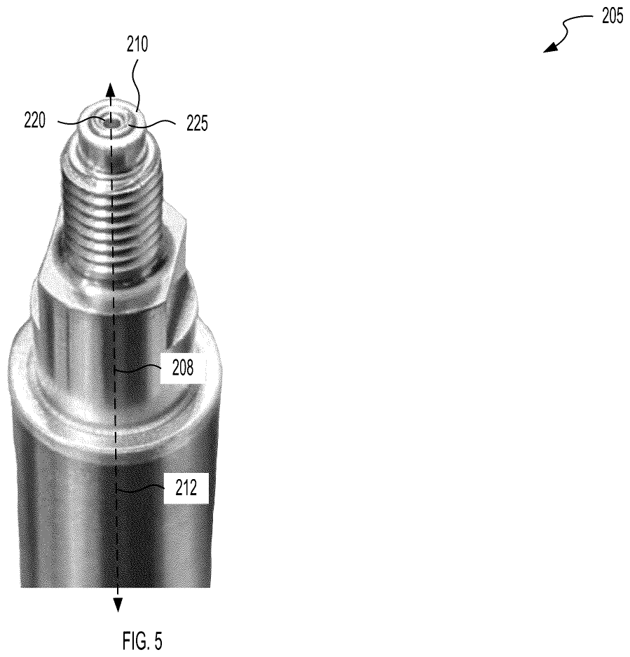

FIG. 5 is a perspective view the first fitting 205. The first fitting 205 can include the first flat surface 210. The first flat surface 210 can be disposed at an end of the first fitting 205. The first flat surface 210 can be oriented perpendicular to the longitudinal axis 208 of the first fitting 205. The first flat surface 210 can extend in a plane perpendicular to the longitudinal axis 212 of the first conduit 215. The longitudinal axis 208 of the first fitting 205 and the longitudinal axis 212 of the first conduit 215 can be parallel. The longitudinal axis 208 of the first fitting 205 and the longitudinal axis 212 of the first conduit 215 can overlap. The first fitting 205 can include the first conduit inlet 220. The first conduit inlet 220 can be disposed at the end of the first fitting 205.

The first fitting 205 can include the protrusion 225. The protrusion 225 can be disposed halfway between the first conduit inlet 220 and the outer edge 235 of the first flat surface 210. The distance between the inner edge of the protrusion 225 and the first conduit inlet 220 can be less than the distance between the outer edge of the protrusion 225 and the outer edge 235 of the first flat surface 210. The distance between the inner edge of the protrusion 225 and the first conduit inlet 220 can be equal to the distance between the outer edge of the protrusion 225 and the outer edge 235 of the first flat surface 210. The distance between the inner edge of the protrusion 225 and the first conduit inlet 220 can be greater than the distance between the outer edge of the protrusion 225 and the outer edge 235 of the first flat surface 210.

A method for providing an assembly for a gas chromatography system can include providing a first fitting. The first fitting can include a first flat surface. The first fitting can include a first conduit intersecting with the first flat surface at a first conduit inlet. The first fitting can include a protrusion disposed on the first flat surface of the first fitting and around the first conduit inlet. The method can include providing a ferrule. The ferrule can include a frustoconical surface. The ferrule can include a second flat surface configured to seal against the protrusion. The ferrule can include a second conduit intersecting with the second flat surface at a second conduit inlet. The second conduit can be aligned with the first conduit. The method can include providing a tube disposed in the first conduit and the second conduit. The tube can be configured to extend through the first conduit inlet and the second conduit inlet. The second conduit can define an interior surface of the ferrule. The interior surface of the ferrule can be configured to seal against an outer surface of the tube.

A method for a gas chromatography mass spectrometry fitting can include providing a fitting. The fitting can include a first flat surface. The fitting can include a first conduit intersecting with the first flat surface at first conduit inlet. The fitting can include a protrusion disposed on the first flat surface of the fitting and around the first conduit inlet. The protrusion can be configured to deform a second flat surface of a ferrule. The ferrule can include a frustoconical surface. The second flat surface can be configured to seal against the protrusion.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

While operations can be depicted in the drawings in a particular order, such operations are not required to be performed in the particular order shown or in sequential order, and all illustrated operations are not required to be performed. Actions described herein can be performed in a different order.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An assembly for a gas chromatography mass spectrometry system, comprising:
a first fitting comprising:
a first flat surface;
a first conduit intersecting with the first flat surface at a first conduit inlet; and
a protrusion disposed on the first flat surface of the first fitting and around the first conduit inlet; and
a ferrule comprising:
a frustoconical surface;
a second flat surface sealed against the protrusion;
a second conduit intersecting with the second flat surface at a second conduit inlet, the second conduit aligned with the first conduit; and
a tube disposed in the first conduit and the second conduit, the tube configured to extend through the first conduit inlet and the second conduit inlet,
wherein the second conduit defines an interior surface of the ferrule, the interior surface of the ferrule sealed against an outer surface of the tube.

2. The assembly of claim 1, wherein the ferrule is disposed a fixed distance from a first end of the tube.

3. The assembly of claim 1, wherein the frustoconical surface is sealed against an interior surface of a second fitting.

4. The assembly of claim 1, further comprising:
a second fitting comprising first threads,
wherein the first fitting comprises second threads configured to mate with the first threads and mating of the first threads and the second threads provides compression of the ferrule.

5. The assembly of claim 1, wherein the frustoconical surface is oblique to the second flat surface.

6. The assembly of claim 1, wherein the protrusion has a first hardness and a surface of the ferrule has a second hardness less than the first hardness.

7. The assembly of claim 1, wherein the second flat surface is configured to deform when making a seal with the protrusion.

8. The assembly of claim 1, wherein the first fitting is disposed at a first end of a mass spectrometer transfer line.

9. The assembly of claim 1, wherein the protrusion is radially symmetric.

10. The assembly of claim 1, further comprising:
a gas chromatograph comprising an oven, wherein the first fitting is disposed inside the oven.

11. The assembly of claim 1, wherein the first flat surface extends in a plane perpendicular to a longitudinal axis of the first conduit.

12. The assembly of claim 1, wherein the protrusion is disposed between the first conduit inlet and an outer edge of the first flat surface.

13. The assembly of claim 1, wherein the protrusion has a shape defined by at least one of a circle, a ring, a square, an ellipse, a triangle, or a polygon.

14. The assembly of claim 1, wherein:
the ferrule comprises at least one of a metal, graphite, or polyimide; and
the first fitting comprises stainless steel.

15. The assembly of claim 1, wherein a mating frustoconical surface of a second fitting presses on the frustoconical surface of the ferrule to cause a seal between an inner diameter of the ferrule and an outer diameter of the tube.

16. The assembly of claim 1, wherein the protrusion has at least one of a semi-circular cross-section or a triangular cross-section.

17. The assembly of claim 1, wherein:
the first flat surface has an inner diameter in a range of 100 μm to 2 mm; and
the first flat surface has an outer diameter in a range of 2 mm to 10 mm.

18. The assembly of claim 1, wherein the ferrule comprises a coating comprising at least one of gold, silver, brass, cooper, plastic, or graphite.

19. The assembly of claim 1, wherein the protrusion has a width in a range of 50 μm to 1 mm.

20. The assembly of claim 1, wherein:
the protrusion has a hardness in a range of HK 140 to HK 200; and
a surface of the ferrule has a hardness in a range of HK 20 to HK 90.
